(19) United States
(12) Patent Application Publication
(10) Pub. No.: US 2007/0246923 A1
(43) Pub. Date: Oct. 25, 2007

(54) Thermally initiatable ignition mixture

(75) Inventors: Lothar Anacker, Gerhardshofen (DE); Karl Bayer, Berg (DE); Matthias Grimm, Zirndorf (DE); Josef Kraft, Berg (DE); Joachim Niederwieser, Roth (DE); Gerrit Scheiderer, Furth (DE); Waldemar Weuter, Furth (DE)

Correspondence Address: FOLEY AND LARDNER LLP;SUITE 500, 3000 K STREET NW, WASHINGTON, DC, 20007, US

(73) Assignee: PETRI-DN GMBH INFLATOR SYSTEMS

(21) Appl. No.: 11/783,284

(22) Filed: Apr. 6, 2007

Related U.S. Application Data
(63) Continuation of application No. PCT/DE05/01750, filed on Sep. 29, 2005.

(30) Foreign Application Priority Data
Oct. 8, 2004 (DE) 10 2004 049 432.0
Dec. 17, 2004 (DE) 10 2004 062 168.3

(51) Int. Cl. B60R 21/26; C06B 29/02

(52) U.S. Cl. 280/741; 149/77

(57) ABSTRACT

The disclosed thermally initiatable ignition mixture comprises 30 to 85% by weight of at least one first inorganic oxidizing agent from the group consisting of the chlorates and at least one second inorganic oxidizing agent from the group consisting of the nitrates; 10 to 55% by weight of at least one combustible selected from the substance class consisting of the dicarboxylic acids, the tricarboxylic acids, the amino acids, the carboxamides, the carboxylic acid hydrazides, the carboxylic acid diamides, the carboxylic acid dihydrazides and/or derivatives thereof, and up to 8% by weight of a metal oxide.

This application is a continuation of International Application PCT/DE2005/001750, which has an international filing date of Sep. 29, 2005; this International Application was not published in English, but was published in German as WO 2006/039892, both of which are incorporated herein by reference in their entirety.

### BACKGROUND

The present invention relates to a substance mixture for producing gases, in particular propellant gases for passenger protection devices in motor vehicles, and to the use of the substance mixture.

Passive safety devices in motor vehicles, for example, airbag systems, contain in a combustion chamber of a gas generator a gas-producing substance mixture in the form of tablets, pellets, moldings or granules which, after electrical activation, produces a propellant gas which in turn inflates a gas bag, thereby permitting the protection of the passengers in the vehicle.

The gas-producing mixtures used in the gas generators of the motor vehicle safety systems are distinguished by a very high stability. Also associated with the high stability is self-triggering, which occurs at high temperature. The gas generators are not designed for an accelerated or excessively vigorous reaction of the gas-producing mixture. The generator housings are additionally weakened in terms of the material strength by the high temperature effect and cannot withstand the resulting pressures in the case of triggering above certain temperature limits. As a result, the passengers in the vehicle may be subject to a significant danger.

In order to avoid this danger, increasing use is being made of thermally initiatable ignition mixtures which are capable of controlled ignition of the gas-producing mixtures usually used in gas generators, below the critical temperature in a temperature function range of 145 to 210° C. This use permits a controlled reaction of the gas-producing mixture in the gas generator, for example in the case of a vehicle fire. A thermally initiatable initial mixture thus ensures, through premature controlled triggering, a safe reaction of the gas-producing mixtures in the passive safety system and thus simultaneously contributes toward minimizing the danger to the passengers.

Various substance mixtures are known as thermally initiatable ignition mixtures. WO 95/26945 describes an ignition mixture comprising an oxidizing agent from the group consisting of the alkali metal and alkaline earth metal chlorates, such as potassium chlorate or sodium chlorate, and a combustible, such as low-melting, readily decomposable organic combustibles from the group consisting of the hydrocarbons, such as monosaccharides, preferably glucose, galactose and ascorbic acid.

DE 19840993 A1 discloses the use of a gas-producing mixture as an ignition mixture comprising at least one nonhygroscopic organic compound having a melting point of less than or equal to 150° C., such as dicarboxylic acids having not more than 5 carbon atoms, urea compounds or triazole compounds, as the combustible, and at least one oxidizing agent from the group consisting of the alkali metal and/or alkaline earth metal nitrates, chlorates or perchlorates.

DE 198 05 976 C1 describes a substance mixture which is used as an early ignition powder for thermal fuses. The mixture comprises nitrates and/or chlorates as oxidizing agents and combustibles comprising thioureas and their derivatives, the oxidation of which, however, leads to the liberation of toxicologically relevant sulfur compounds, such as sulfur dioxide or hydrogen sulfide.

A further laid-open application DE 197 30 873 A1 describes substance mixtures for use as thermal fuses, which contain an oxidizing agent from the class consisting of the oxalates, persulfates, nitrates, peroxides, explosives, such as nitroguanidine or 5-aminotetrazole nitrate and optionally, as a reducing agent, a metal powder. The use of explosives in ignition mixtures is, however, a major disadvantage in view of the necessary safety measures for the use thereof in cars.

### SUMMARY

The thermal ignition mixtures known from the prior art accordingly have, as a rule, components which have a high rate of formation of toxicologically relevant gases and are classed as explosives, which is not advantageous for the general safety of passengers in vehicles.

The problem to be solved by the invention is therefore to provide a thermally initiatable substance mixture for use in gas generators of motor vehicle safety systems, which has high thermal and chemical stability, is free of compounds classed as explosives, can be easily processed and is ecologically compatible.

This complex object is achieved in a simple as well as surprisingly effective manner by a substance mixture for producing gases comprising a thermally initiatable ignition mixture which (a) contains at least one inorganic oxidizing agent from the group consisting of the chlorates and at least one second inorganic oxidizing agent from the group consisting of the nitrates, and additionally (b) contains at least one combustible which is selected from the substance class consisting of the dicarboxylic acids, the tricarboxylic acids, the amino acids, the carboxamides, the carboxylic acid hydrazides, the carboxylic acid diamides, the carboxylic acid dihydrazides and/or derivatives thereof.

The substance mixture according to an embodiment of the present invention is based on a pyrotechnical mixture whose components are not classed as explosives and are therefore ecologically compatible. This results in higher safety characteristics and, associated therewith, a simpler manufacturing process, which is reflected in lower manufacturing costs. It is also possible to use different production processes, whereas the production of substance mixtures of explosives is limited to a few methods for safety reasons. Since the substance mixture according to an embodiment of the present invention is based on a pyrotechnical mixture, a constant product quality can be ensured by a reliable manufacturing process.

Furthermore, the substance mixture according to an embodiment of the present invention offers the possibility of a controlled setting of the thermal initiation point by the choice or modification of the combustible components or amounts of combustible components used in the mixture. The pyrotechnical mixture also permits the setting of different oxygen balances by the specific choice of the oxidizing agents and the weight ratios thereof in the formulation. Consequently, a further minimization of harmful gas components, such as carbon monoxide or oxides of nitrogen, in the passive safety systems can additionally be achieved.

The substance mixture advantageously comprises from 30 to 85% by weight, preferably from 40 to 65% by weight of at least one inorganic oxidizing agent from the group consisting of the chlorates and at least one inorganic oxidizing agent from the group consisting of the nitrates and from 10 to 55% by weight, preferably from 20 to 40% by weight, of a combustible which is selected from the substance class consisting of the dicarboxylic acids, the tricarboxylic acids, the amino acids, the carboxamides, the carboxylic acid hydrazides, the carboxylic diamides, the carboxylic acid dihydrazides and/or derivatives thereof.

Preferably used inorganic oxidizing agents are compounds from the group consisting of the alkali metal and/or alkaline earth metal chlorates and the alkali metal and/or alkaline earth metal nitrates, in particular potassium chlorate KClO₃ and potassium nitrate KNO₃.

Preferably used combustibles are glycine, β-alanine, L-glutamine, L-glutamic acid, oxalic acid, oxalic acid diamide, oxalic acid dihydrazide, malonic acid, malonic acid diamide, malonic acid dihydrazide, succinic acid, succinic acid diamide, glutaric acid, adipic acid, adipic acid diamide, tartaric acid, barbituric acid, citric acid and azodicarboxylic acid diamide.

In the presence of KClO₃ and KNO₃, the preferred combustibles have a sufficiently low ignition temperature of 145° C. to 210° C. so that the substance mixture can also be used in gas generators comprising materials having a relatively low strength, such as, for example, aluminum.

In order to increase the long-term stability, component combinations, in particular comprising β-alanine, barbituric acid, glycine, malonic acid diamide and/or oxalic acid dihydrazide, are advantageously added to the substance mixture.

Advantageously, the substance mixture contains up to 8% by weight of a metal oxide or transition metal nitrate as catalysts. The metal oxides belong in particular to the group consisting of the cobalt oxides, copper oxides, iron oxides and/or silver oxide. Copper oxide is preferably used. Preferably used transition metal nitrates are copper nitrate and silver nitrate.

Up to 5% by weight of customary processing auxiliaries, such as flow improvers, lubricants and/or press auxiliaries, in particular Aerosil, alumina, boron nitride and/or graphite, are also added to the substance mixture according to an embodiment of the present invention.

For improving the ignition strength, up to 5% by weight of one or more additives, in particular metal powders, boron or silicon, are mixed with the substance mixture.

In addition, the substance mixture has further inorganic oxidizing agents from the group consisting of the perchlorates and peroxides.

The functioning temperatures of the gas-producing substance mixture can be adjusted within certain ranges. This is preferably effected in a temperature function range of 145° C. to 210° C. The triggering temperature is preferably from 155° C. to 195° C.

The substance mixture according to an embodiment of the present invention has a high thermal and long-term stability. Thus, the mass loss on the storage at temperatures of 100° C. to 120° C., preferably at 110° C., over a period of up to 600 hours is less than 7% by weight, preferably 5% by weight.

For simpler use, the substance mixture according to an embodiment of the present invention is present in the form of pellets, tablets and/or granules having a particle size from 0.2 to 5 mm, which are produced by known processes. The manufacturing processes are based on the shaping of the mixture in the form of powder by pressing to provide tablets; kneading, extrusion or extrusion molding to provide moldings; and granulation by breaking and screening the moldings and tablets or granulation by tumbling or extrusion. The mixtures to be processed may be dry, moistened or solvent-containing. The addition of a binder is also possible.

The substance mixture can be used in various ways. One use to be envisioned is the employment of the substance mixture as a thermally initiatable ignition mixture in a gas generator for producing propellant gases for passenger protection devices in motor vehicles, the substance mixture being present in the form of tablets and/or granules in a gas generator. The solid substance mixture can alternatively be housed in a separate location in the gas generator or in the ignition chain itself.

The substance mixture can also be used in other areas of pressure and safety elements. The applications to be envisioned are using the substance mixture alone or in combination with other gas-producing substances or booster charges in various gas generators, pressure elements, ignition elements, micro gas generators, triggering mechanisms in the case of fire and thermal protection devices.

It is to be understood that both the foregoing general description and the following detailed description are exemplary and explanatory only, and are not restrictive of the invention as claimed.

### BRIEF DESCRIPTION OF THE DRAWINGS

Further features and advantages of the present invention will become apparent from the following description of the plurality of working examples, appended claims, and the exemplary embodiments shown in the drawings, which are briefly described below.

FIG. 1 shows a table in which the ratio of mass loss and load duration at 110° C. during a stability test (so-called Holland test) is shown.

FIG. 2 shows a diagram with the ratio of the SDTA (single differential thermal analysis) signal position and load duration after loading at 110° C. as a function of type and amount of the substance mixture used.

### DETAILED DESCRIPTION

Working Example 1

25.8 g of oxalic acid dihydrazide, 6.5 g of glycine, 12.9 g of potassium chlorate, 51.6 g of potassium nitrate, 3.2 g of copper (II) oxide and 2 g of boron nitride were milled with one another and homogenized in a porcelain mortar for about 15 minutes. The mixture was then pressed on a press to produce tablets having a diameter of 8 mm and a height of 2 mm and then crushed to give 1.4 to 4 mm granules or directly processed to produce tablets having a diameter of 4 mm and a height of about 1.8 mm. The sensitivity to friction of the powder to be pressed to produce the tablets or of the granules is greater than 360 N and the sensitivity to impact is 30J.

The deflagration points determined for the substance mixture are 173° C. without thermal loading, 175° C. after storage for 100 h at 110° C., corresponding to the Holland test, 171° C. after 330 hat 110° C. and 170° C.after 600 h at 110° C.

Furthermore, 5.2 g of gas charge tablets comprising customary gas-producing substance mixtures used in series and 0.6 g of tablets comprising a thermally initiatable ignition mixture (TII) according to the above working example were operated in a standard gas generator and the NO₂, NO and CO gas concentrations were measured in a 2.5 m³ test chamber. The results are shown in Table 1 below.

TABLE 1

| | NO₂ (ppm) | NO (ppm) | CO (ppm) |
|---|---|---|---|
| 5.8 g gas charge | 0.1 | 2.4 | 51 |
| 5.2 g gas charge + 0.6 g TII | 0.1 | 1.1 | 42 |
| (example 1) | | | |

As is evident from Table 1, the use of the TII mixture leads to substantially lower rates of formation of carbon monoxide and nitric oxide in the reaction. The emission of harmful gases is thus reduced in comparison with the ignition mixtures known to date.

Working Example 2

Components corresponding to Table 2 below were weighed in and were milled with one another and homogenized in a porcelain mortar for about 15 minutes. Sensitivities of the mixtures to friction and impact were determined.

TABLE 2

| | Mixtures | | | | |
|---|---|---|---|---|---|
| | No. 1 | No. 2 | No. 3 | No. 4 | No. 5 |
| Copper(II) oxide (g) | 0.32 | 0.32 | 0.32 | 0.32 | 0.32 |
| Potassium chlorate (g) | 3.22 | 1.93 | 1.29 | 2.58 | 1.29 |
| Strontium nitrate (g) | 3.23 | 4.52 | 5.16 | — | — |
| Potassium nitrate (g) | — | — | — | 3.87 | 5.16 |
| Oxalic acid | 3.23 | 3.23 | 3.23 | 3.23 | 3.23 |
| dihydrazide (g) | | | | | |
| Sensitivity to friction | 118 | 157 | 353 | 235 | ≧353 |
| (N) | | | | | |
| Sensitivity to impact | ≧19.62 | ≧19.62 | ≧19.62 | 19.62 | 19.62 |
| (J) | | | | | |

The unit for specifying the sensitivity to friction is the Newton, a higher value meaning a lower sensitivity to friction.

Mixtures 1 to 3 and mixtures 4 and 5 are examples for the reduction of the sensitivity to friction of the pyrotechnical mixture according to an embodiment of the present invention due to a reduction in the proportion of potassium chlorate and with the simultaneous corresponding increase in the nitrate proportion. A low sensitivity to friction permits better processing and a higher long-term stability of the substance mixture processed to produce tablets or granules, due to a higher strength of the material to be pressed.

Working Example 3

Components corresponding to Table 3 below were weighed in and were milled with one another and homogenized in a porcelain mortar for about 15 minutes. The deflagration point and the SDTA signal of the mixtures were then measured.

TABLE 3

| | Mixtures | | | | | |
|---|---|---|---|---|---|---|
| | No. 1 | No. 2 | No. 3 | No. 4 | No. 5 | No. 6 |
| Copper(II) oxide (% by wt.) | — | 0.66 | 1.96 | 3.23 | — | — |
| Iron (turnings) (% by wt.) | — | — | — | — | 3.23 | — |
| Cobalt oxide (% by wt.) | — | — | — | — | — | 3.23 |
| Potassium chlorate (% by | 13.33 | 13.25 | 13.07 | 12.90 | 12.90 | 12.90 |
| wt.) | | | | | | |
| Potassium nitrate (% by wt.) | 53.33 | 52.98 | 52.29 | 51.61 | 51.61 | 51.61 |
| Glycine (% by wt.) | 6.67 | 6.62 | 6.54 | 6.45 | 6.45 | 6.45 |
| Oxalic acid dihydrazide (% | 26.67 | 26.49 | 26.14 | 25.81 | 25.81 | 25.81 |
| by wt.) | | | | | | |
| Deflagration point (° C.) | 210-216 | 184 | 178 | 174 | 181 | 194 |
| SDTA signal position (° C.) | 232 | 185 | 179 | 174 | 182 | 197 |

Table 3 shows possible influences on the initiation point through the use of catalysts in mixtures, on the basis of the deflagration point and the SDTA signal position. It is clear that both the amount of catalyst used and the type of catalyst influence the initiation point and deflagration point. Thus, mixture 4 comprising 3.23% by weight of copper(II) oxide has the lowest deflagration point of 174° C., whereas the use of the same amount of cobalt oxide increases the deflagration point to 194° C.

Working Example 4

Components corresponding to Table 4 were weighed in and were homogenized analogously to example 3. The deflagration point and the SDTA signal of the mixtures were then measured.

TABLE 4

| | Mixtures | | | | | | | |
|---|---|---|---|---|---|---|---|---|
| | No. 1 | No. 2 | No. 3 | No. 4 | No. 5 | No. 6 | No. 7 | No. 8 |
| Copper(II) oxide (% by wt.) | 3.23 | 3.23 | 3.23 | 3.23 | 3.23 | 3.23 | 3.23 | 3.23 |
| Potassium chlorate (% by wt.) | 12.90 | 12.90 | 12.90 | 9.67 | 12.90 | 32.26 | 19.35 | 22.58 |
| Potassium nitrate (% by wt.) | 51.61 | 51.61 | 51.61 | 29.03 | 51.61 | 32.26 | — | — |
| Strontium nitrate (% by wt.) | — | — | — | — | — | — | 45.16 | 41.93 |
| Potassium perchlorate (% by wt.) | — | — | — | 25.81 | — | — | — | — |
| Adipic acid diamide (% by wt.) | 6.45 | — | — | — | — | — | — | — |
| Barbituric acid (% by wt.) | — | 6.45 | — | — | — | 32.25 | — | — |
| Adipic acid (% by wt.) | — | — | 6.45 | — | — | — | — | — |
| Glycine (% by wt.) | — | — | — | 6.45 | — | — | — | — |
| Oxalic acid dihydrazide (% by wt.) | 25.81 | 25.81 | 25.81 | 25.81 | 19.36 | — | — | — |
| Malonic acid diamide (% by wt.) | — | — | — | — | 12.90 | — | 32.26 | — |
| Glutamic acid (% by wt.) | — | — | — | — | — | — | — | 32.26 |
| Deflagration point (° C.) | 179 | 170 | 159 | 179 | 182 | 176 | 194 | 185 |
| SDTA signal position (° C.) | 176 | 169 | 164 | 179 | 176 | 179 | 196 | 186 |
| SDTA signal size (in sct) | 111 | 106 | 117 | 112 | 110 | 114 | 102 | 79 |

sct = data in scale units.

Table 4 shows the influence of the combustible components on the properties of the thermal early ignition mixture. The triggering temperature and ignition strength can be adjusted by the specific choice of the combustibles and the mixing ratio thereof. Thus, the triggering temperature determined by deflagration point and SDTA signal position is the lowest in the case of mixture no. 4 comprising adipic acid and oxalic acid dihydrazide.

The addition or substitution of further combustible components can influence the function temperature. This is shown by mixture numbers 1 to 6 where an increase in the triggering temperature by the replacement of adipic acid by barbituric acid or adipic acid diamide from about 160° C. to about 170° C. or 180° C., respectively, is brought about. An analogous effect can be achieved by the substitution of potassium nitrate by strontium nitrate, as shown in mixture numbers 7 and 8. A similar trend is recorded in the case of the ignition strength, determined by the SDTA signal size, the signal size here being a measure of the energy liberated during the ignition process.

By the suitable combination of combustibles and combustible mixtures, the ignition strength required in each case can be adjusted in order to ensure safe combustion of the gas-producing mixture to be ignited.

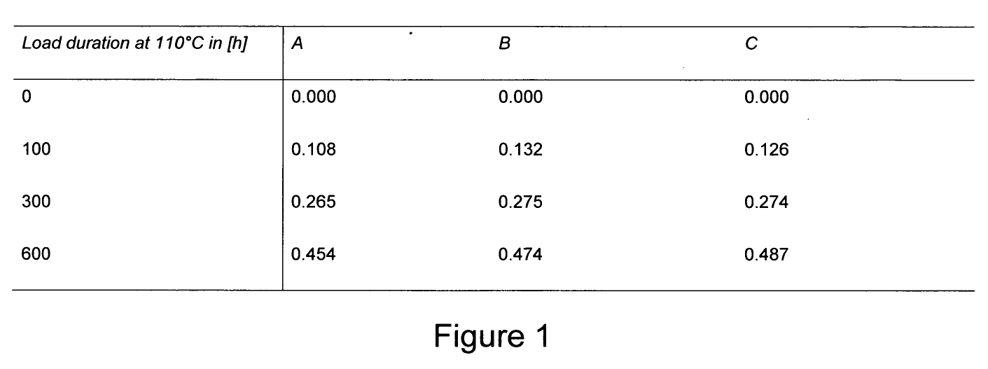

FIG. 1 shows the result of a Holland test of a substance mixture according to working example 1 (designated as TII-1) at a temperature of 110° C. over a period of 0 to 600 h. Column A designates the mass loss of TII-1 in % by weight at a charge mass of 2 g of granules, column B designates the mass loss of TII-1 in % by weight at a charge mass of 4 g of granules and column C designates the mass loss of TII-1 in % by weight at a charge mass of 4 g of tablets. As is evident from the measured values, the decrease in weight of the substance mixture according to an embodiment of the present invention was from 0.108% by weight to 0.132% by weight after 100 h and from 0.454% by weight to 0.487% by weight after 600 h. Thus, the substance mixture according to the invention has a higher long-term stability in comparison with conventionally used mixtures.

The resultant variations in the mass losses are due in particular to the mass of the substance mixture used. With increasing charge mass, the mass loss increases; thus, the mass loss in the case of a charge mass of 4 g of granules after 600 h is 4.4% above that in the case of a charge mass of 2 g of granules. On the other hand, the processing form of the substance mixture as granules or tablets has no particular effects on the mass loss.

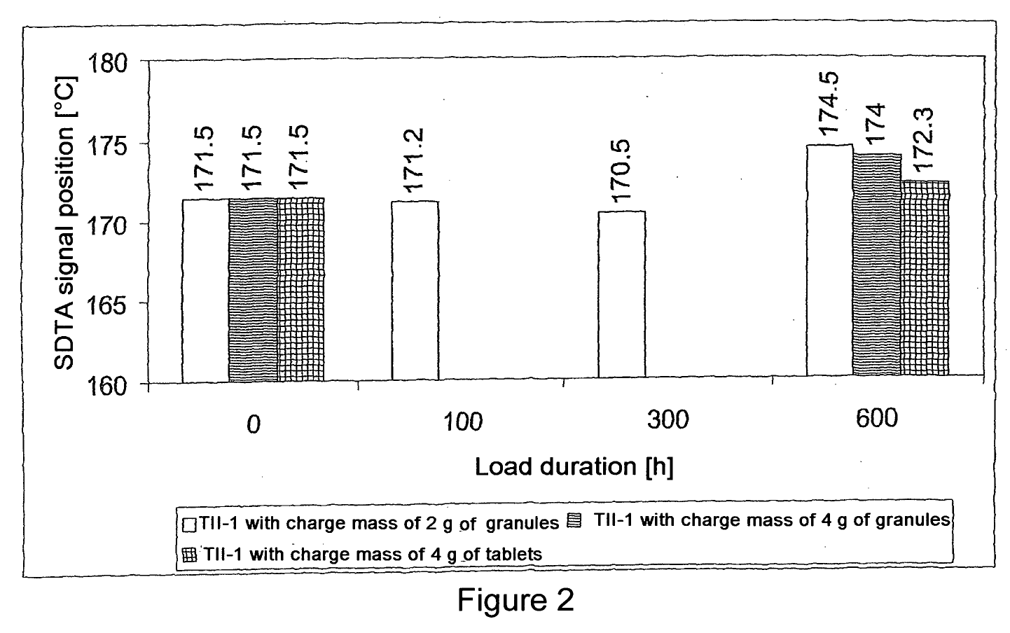

The diagram shown in FIG. 2 shows the SDTA signal position of an ignition mixture according to working example 1 (designated as TII-1) after loading at 110° C. according to the Holland test for a charge mass of 2 g of granules, 4 g of granules and 4 g of tablets. Here too the diagram clearly shows that the properties of the ignition mixtures do not change substantially even after loading and are therefore not subject to any aging process as in the case of conventional ignition mixtures. The ignition temperatures do not increase substantially even after a load duration of 600 h. Thus, the ignition temperatures of the mixtures are 171.5° C. in the unloaded state and between 172.3 for a charge mass of 4 g of tablets, 174° C. for a charge mass of 4 g of granules and 174.5° C. for a charge mass of 2 g of granules after loading at 110° C. for 600 h. A dependence on the processing form is not observable, and the influence of the mass of the substance mixture used is also negligible.

The invention is not limited in its implementation to the abovementioned preferred working examples. Rather, a number of variants is conceivable, which make use of the substance mixture according to the invention and the use thereof also in fundamentally different embodiments.

The two German priority applications: DE 10 2004 049 432.0 filed Oct. 8, 2004, and DE 10 2004 062 168.3 filed Dec. 17, 2004, are all incorporated by reference herein in their entireties.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. A substance mixture for producing propellant gases for a passenger protection device in a motor vehicle, comprising:
a thermally initiatable ignition mixture, wherein the thermally initiatable ignition mixture comprises:
30 to 85% by weight of at least one first inorganic oxidizing agent from a group consisting of the chlorates and at least one second inorganic oxidizing agent from the group consisting of the nitrates;
10 to 55% by weight of at least one combustible selected from a group consisting of the dicarboxylic acids, the tricarboxylic acids, the amino acids, the carboxamides, the carboxylic acid hydrazides, the carboxylic acid diamides, the carboxylic acid dihydrazides and/or derivatives thereof; and
an amount of a metal oxide wherein the amount of metal oxide is up to 8% by weight of the thermally initiatable ignition mixture.

2. The substance mixture as claimed in claim 1, wherein the substance mixture comprises 40 to 65% by weight of the at least one inorganic oxidizing agent and that at least one second inorganic oxidizing agent.

3. The substance mixture as claimed in claim 1, wherein the substance mixture comprises 20 to 40% by weight of the at least one combustible.

4. The substance mixture as claimed in claim 1, wherein the at least one first inorganic oxidizing agents comprises an alkali metal chlorate, an alkaline earth metal chlorate, or a combination thereof, and the at least one second inorganic oxidizing agent comprises an alkali metal nitrate, an alkaline earth metal nitrate, or a combination thereof.

5. The substance mixture as claimed in claim 1, wherein the at least one first inorganic oxidizing agents comprises potassium chlorate, and the at least one second inorganic oxidizing agent comprises potassium nitrate.

6. The substance mixture as claimed in claim 1, wherein the at least one combustible is glycine, β-alanine, L-glutamine, L-glutamic acid, oxalic acid, oxalic acid diamide, oxalic acid dihydrazide, malonic acid, malonic acid diamide, malonic acid dihydrazide, succinic acid, succinic acid diamide, glutaric acid, adipic acid, adipic acid diamide, tartaric acid, barbituric acid, citric acid, azodicarboxylic acid diamide, or any combination thereof.

7. The substance mixture as claimed in claim 1, wherein the metal oxide is selected from the group consisting of the cobalt oxides, copper oxides, iron oxides, silver oxide, or a combination thereof.

8. The substance mixture as claimed in claim 1, wherein the metal oxide is copper oxide.

9. The substance mixture as claimed in claim 1, wherein the substance mixture further comprises up to 5% by weight of processing auxiliaries.

10. The substrate mixture as claimed in claim 9, wherein the processing auxiliaries comprise flow improvers, lubricants, press auxiliaries, or a combination thereof.

11. The substrate mixture as claimed in claim 9, wherein the processing auxiliaries comprise alumina, boron nitride, graphite, or a combination thereof.

12. The substance mixture as claimed in claim 1, wherein the substance mixture further comprises up to 5% by weight of metal powder, boron, silicon, or a combination thereof.

13. The substance mixture as claimed in claim 1, wherein the substance mixture further comprises at least one third inorganic oxidizing agent from the group consisting of perchlorates and peroxides.

14. The substance mixture as claimed in claim 1, wherein a triggering temperature of the substance mixture is 145° C. to 210° C.

15. The substance mixture as claimed in claim 14, wherein the triggering temperature of the substance mixture is from 155° C. to 195° C.

16. The substance mixture as claimed in claim 1, wherein the substance mixture has a mass loss of less than 7% by weight on storage from 100° C. to 120° C. over a period of up to 600 hours.

17. The substance mixture as claimed in claim 16, wherein the substance mixture has a mass loss of less than 5% by weight on storage at from 110° C. over a period of up to 600 hours.

18. The substance mixture as claimed in claim 1, wherein the substance mixture is present in form of pellets, tablets, granules, or a combination thereof having a particle size of 0.2 to 5 mm.

19. A gas generator for producing propellant gases comprising:
a substance mixture comprising a thermally initiatable ignition mixture, wherein the thermally initiatable ignition mixture comprises:
30 to 85% by weight of at least one first inorganic oxidizing agent from the group consisting of the chlorates and at least one second inorganic oxidizing agent from the group consisting of the nitrates,
10 to 55% by weight of at least one combustible selected from the substance class consisting of the dicarboxylic acids, the tricarboxylic acids, the amino acids, the carboxamides, the carboxylic acid hydrazides, the carboxylic acid diamides, the carboxylic acid dihydrazides and/or derivatives thereof, and
an amount of a metal oxide, wherein the amount of metal oxide is up to 8% by weight of the thermally initiatable ignition mixture.

20. The gas generator as claimed in claim 19, wherein the thermally initiatable ignition mixture is present in the form of tablets, granules, or a combination thereof in the gas generator

21. A passenger protection device for a motor vehicle comprising:
a gas generator comprising a substance mixture, wherein the substance mixture comprises a thermally initiatable ignition mixture, and the thermally initiatable ignition mixture comprises:
30 to 85% by weight of at least one first inorganic oxidizing agent from the group consisting of the chlorates and at least one second inorganic oxidizing agent from the group consisting of the nitrates,
10 to 55% by weight of at least one combustible selected from the substance class consisting of the dicarboxylic acids, the tricarboxylic acids, the amino acids, the carboxamides, the carboxylic acid hydrazides, the carboxylic acid diamides, the carboxylic acid dihydrazides and/or derivatives thereof, and
an amount of a metal oxide, wherein the amount of metal oxide is up to 8% by weight of the thermally initiatable ignition mixture.

22. The passenger protection device as claimed in claim 21, wherein the thermally initiatable ignition mixture is present in the form of tablets, granules, or a combination thereof in the gas generator.
